(19) United States
(12) Patent Application Publication
(10) Pub. No.: US 2016/0136816 A1
(43) Pub. Date: May 19, 2016

(54) SORTING APPARATUS AND METHOD

(71) Applicant: James Charles Pistorino, Menlo Park, CA (US)

(72) Inventor: James Charles Pistorino, Menlo Park, CA (US)

(21) Appl. No.: 14/541,157

(22) Filed: Nov. 14, 2014

(51) Int. Cl. B25J 9/16; B65B 11/00

(52) U.S. Cl. CPC B25J 9/1697; B65B 11/00; B25J 9/1679

(57) ABSTRACT

A system for sorting comprising an x-y-z stage including a suction cup attached thereto, a camera, a computer connected to the x-y-z stage and the camera, and a translucent platform for sorting with the platform mounted below the camera and the x-y-z stage.

### I. BACKGROUND

A. Field of the Invention

The invention relates to the fields of electro-mechanical sorting systems, data processing systems, and food service related machinery.

B. Description of Related Art

Sorting/separating and/or counting items from a group or mixed bunch is a task that is frequently encountered in manufacturing and processing items. For example, a batch of walnuts might need to be: 1) counted; 2) sorted to separate discolored walnuts from desired walnuts; 3) sorted to separate broken walnuts from whole walnuts; and/or 4) sorted based on a variety of other selection criteria.

The task of sorting/separating and/or counting items from a group or mixed bunch can be classified in two ways: 1) sorting items with regular/consistent shapes/characteristics; and 2) sorting items with irregular shapes/characteristics or mixed items.

The need to sort items with regular or consistent shapes frequently occurs in manufacturing and operating environments. For example, in the manufacturing of nuts or bolts, each item is substantially regular such that highly engineered processing equipment that relies on regularity can be used. Vibratory feeder bowls are one such piece of equipment. Typically, this equipment relies on the fact that the items are (1) unmixed (e.g., only nuts or only bolts); (2) substantially regular; (3) serially presented; and/or (4) not entangled so that they may be processed mechanically. Often, each sorting device is specific to the characteristics of a particular item. Thus, sorting different items requires different sorting apparatus and/or substantial reconfiguration of the hardware components.

Similarly, sorting items of irregular or inconsistent shapes, or mixed items, is a difficult problem encountered in a variety of manufacturing and operating situations. An exemplary situation is the processing of mixed eating utensils in either manufacturing, cleaning, or sorting operations. For example, styles of utensils vary greatly in their dimension, weight, color and other physical characteristics. Accordingly, mechanical equipment (e.g., a vibratory feeder bowl) designed to process one style of spoon is unlikely to work for another style of spoon. Moreover, even among spoons of the same style, substantial variation often exists in other physical characteristics such as weight, shape, or color.

Another layer of difficulty is encountered processing a mixed group of eating utensils which may include forks, knives, spoons or other items (e.g., soup spoons, serving spoons, butter knives, pickle forks, etc.). Equipment to process such a group must separate and process each item. Designing equipment with such flexibility is challenging.

Yet another level of difficulty in sorting, separating, counting and/or packaging eating utensil is presented by fork tines. Fork tines contribute to forks becoming entangled with each other and other comingled eating utensils including knives and spoons. Thus, sorting and processing eating utensils from a mixed group has presented a difficult problem for manufacturers, vendors and others handling such a mixed group.

One approach to sorting mixed items relies on material properties. For example, some sorting equipment sorts metallic from non-metallic items using magnetism. Although this approach can work in some instances, it may not be suitable for instances where the items to be sorted from each other are either all austenic or non-austenic or where the different magnetic properties vary by small or difficult to control or predict amounts. Even in the case where all austenic sorting can be used, such sorting equipment is limited to items that are metallic and can be effectively magnetized. Accordingly, sorting equipment that relies on the regularity of the austenic property has limited flexibility and funcationality.

One effort to separate and process a mixed group of eating utensils is described in Akella (2008). This method is designed to process only utensils that can be magnetized. In Akella, mixed utensils are placed in a vibrating, sloped bin with baffles. As a utensil falls through the bin and the baffles, it is separated until it collects at a point against a moving conveyor that is sloped. Beneath the conveyor are a series of moving magnets. As the magnets pass the collected utensils, utensils are attracted and carried towards an electronic camera. Software processes images from the camera to identify the utensil as it passes the camera by examining the perimeter and area of the item. The utensil continues on the conveyor until it reaches a series of selectors. A selector corresponds to each type of utensil (e.g., fork, knife, or spoon) which is under control of a processor running an image processing algorithm. Items that are unrecognized continue on the conveyor to a final selector where they are collected in a bin for out-of process attention. A similar style of device is the ACS-400C cutlery sorting system manufactured by Wexiodisk.

Although this approach has advantages over other solutions, it suffers from a number of drawbacks. One deficiency is that the method works only on utensils that can be magnetized. Many common styles of eating utensils are not susceptible to magnetization including those made of plastic, wood or non-austenic metal. Further, many styles of utensils are made from a combination of metal (which may or may not be sufficiently magnetizable) and another material (e.g., wood on wooden handles). These items either cannot be sorted by equipment relying on magnetism or cannot be sorted meaningfully, i.e., with sufficient sorting to avoid a significant portion being unsorted. Another drawback of this method is the size of the sorting mechanism. The elements of such a system, i.e., bin, conveyor belt, and selector, require a significant area and are not practical in areas with limited space, including, but not limited to, restaurants.

Accordingly, a pressing need exists for equipment that can sort, separate or count items, especially mixed items, that does not rely on a material property or its regularity as the principal sorting feature. The present invention overcomes many of the disadvantages of prior systems and methods. As a subset of the more general sorting/separating problem, a pressing need exists for equipment that can sort, separate and count eating utensils, particularly when such utensils are comingled.

Comingled utensils are a common occurrence in the food service industry. For example, mixed soiled utensils are collected and then either: 1) sorted before being placed in dishwashing trays; or 2) placed mixed in dishwashing trays and sorted after washing. Frequently, the sorted utensils are assembled into groups (e.g., fork/knife/spoon, fork/knife, fork/spoon, or another group) and wrapped in either a paper or linen napkin. In the food service industry, utensils wrapped in a napkin are often referred to as “roll-ups.” Roll-ups are used in the food service industry for numerous reasons including 1) enabling more rapid setting of dining tables and 2) protecting eating utensils from contamination before use, which contamination may result from being touched by personnel prior to use. A roll-up facilitates a rapid table setting with the correct number and combination of utensils.

Although roll-ups have the above described advantages, one significant disadvantage is the time and cost needed to assemble the roll-ups. Typically, servers, bus persons, hosts, bar staff, or other food service personnel spend significant amounts of time assembling roll-ups before, after, or during food service shifts. In some cases, in view of the significant time required to prepare roll-ups, a food service establishment, manufacturer or supplier, may hire personnel for the primary task of preparing roll-ups which adds to labor costs.

In addition to cost, preparing roll-ups is known to be a disfavored task among food service employees because it is perceived as monotonous, repetitious, unskilled and/or mindless. Further, the task does not directly result in increased income because it does not result in gratuities which typically are a significant component for such food service personnel. These factors cause significant problems for food service managers who must hire, train and supervise employees assembling roll-ups. In addition, employment laws and regulations often affect which employees can be assigned a roll-up task, their compensation, work breaks and other employment issues.

Finally, roll-ups inherently involve health risks because cleaned utensils are handled by food service personnel before use by a diner. Even with strict hygiene practices, the handling of washed utensils by food service workers is a potential source of contamination and illness. A single health related incident at a food service establishment can effectively terminate a food service business. Thus, there is a pressing need for a system and method that can separate and sort utensils, and assemble such utensils in various groups, preferably wrapped in a napkin, in an automated fashion.

### II. SUMMARY OF THE INVENTION

The problem of sorting mixed items is addressed by using an x-y-z stage connected to a computer and one or more cameras. The camera(s) take images of items to be sorted. Using the information of the image, the computer directs the x-y-z stage to a desired location where a vacuum is applied through a suction cup to retrieve an item.

In one embodiment, items to be sorted are placed on a sorting table. In yet other embodiments, the sorting table is lit from above to facilitate imaging by the camera(s). In yet other embodiments, the sorting table is translucent and lit from below to further facilitate imaging by enhancing contrast. In further embodiments, the sorting table includes one or more fiducial markers to facilitate determining the relative position of items in the image.

In yet further embodiments, a camera looks up at retrieved items to verify the item actually retrieved. In yet further embodiments, the suction cup is provided with the ability to rotate and a look up camera provides an image of the item retrieved to enable the connected computer to determine how to rotate the item to achieve a desired orientation. In another embodiment, the suction cup is a bellows type. In another embodiment, the sorting platform is made of HDPE.

When used with utensils, yet a further embodiment includes a wrapping mechanism that can roll utensil assemblies in a napkin to form a roll-up.

### III. BRIEF DESCRIPTION OF THE DRAWINGS

FIG. 1 is a cross sectional view showing major components of the apparatus.

FIG. 2 is an overhead view of the sorting platform;

FIGS. 3A and 3B depict fields of views of look down cameras.

FIGS. 4A and 4B depict the fields of view and heights of the look down cameras of FIGS. 3A and 3B respectively.

FIG. 5 is an overhead view of the sorting platform depicting regions that may be designated.

FIGS. 6A and 6B depict alternative sorting platform and support structures.

FIG. 7 is a cross sectional view depicting an alternative arrangement of the XYS stage.

FIGS. 8A and 8B are overhead and side views of item orientation.

FIG. 9 is a block diagram of control components.

FIG. 10 is a detailed view of the pick-up head.

FIGS. 11A, 11B, and 11C depict the components of and axes of movement of the XYZ stage.

FIG. 12 is an exterior view of the apparatus.

FIG. 13 is a flow diagram of image processing steps.

The drawings are intended to depict only the general features and relationship of the items depicted therein in exemplary embodiments and are not to scale.

### IV. DETAILED DESCRIPTION OF THE PREFERRED EMBODIMENTS

Exemplary embodiments will be described hereinafter with reference to the accompanying drawings, in which exemplary embodiments and examples are shown. Like numbers refer to like elements throughout. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated and designated in a wide variety of different configurations. Further, in the following description, numerous details are set forth to further describe and explain one or more embodiments. Although these details are helpful to explain one or more embodiments of the disclosure, those skilled in the art will understand that these specific details are not required to practice the inventions set forth in the claims.

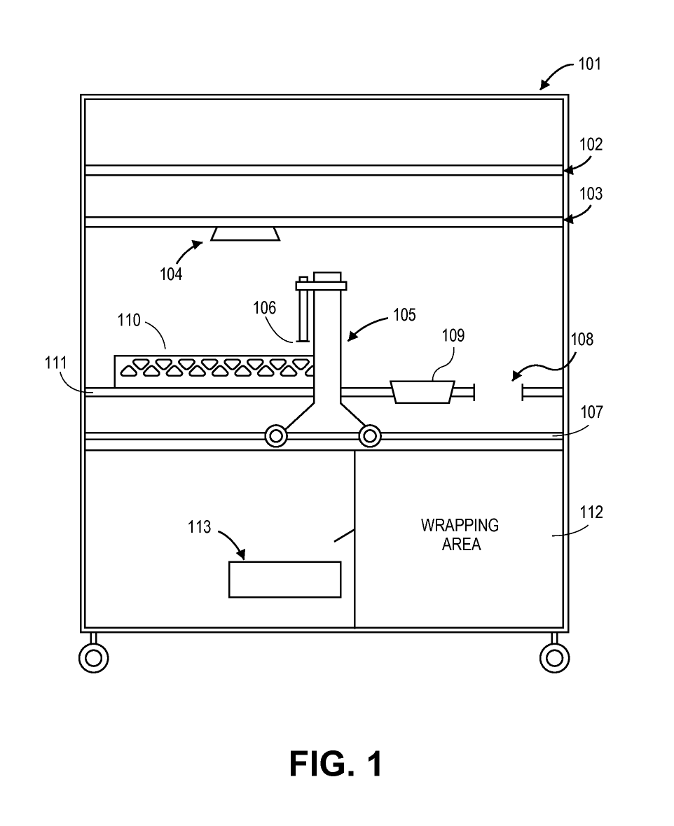

FIG. 1 depicts the general layout of a preferred embodiment of the invention. Shown there is a utensil sorting and wrapping apparatus (101). Starting at the top, shown there are light panel (102), camera(s) support/diffuser panel (103), camera(s) (104), XYZ stage (105) including pick-up head (106), sorting platform (111) including lookup camera(s) (109), and pass through aperture (108). Apparatus (101) further includes a light panel (107), wrapping area (112) and collection bin (113). The individual items are further described below.

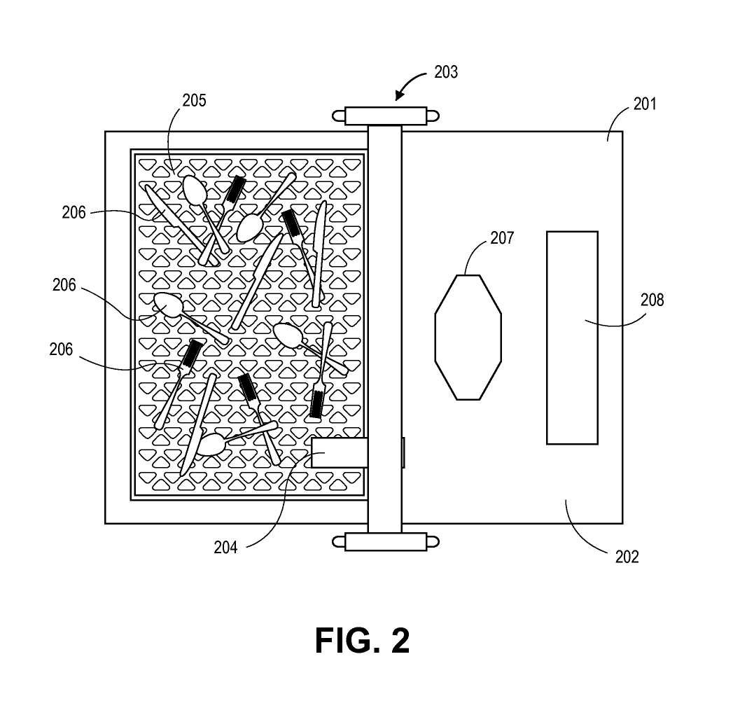

Although not part of the apparatus itself, also shown is dishwashing tray 110. As shown in FIG. 2, dishwashing tray 205 may contain utensils for sorting. Sorting items from a dishwashing tray eliminates the step of unloading utensils from the tray and, therefore, facilitates operations. Nevertheless, any container for utensils may used or no container used at all. Because it is envisioned that a dishwashing tray will be used, the description that follows assumes use of a dishwashing tray but it is not intended to be limiting.

Not shown in FIG. 1 are additional components, including a control computer, CNC controller, and pneumatic air source and controller. The relationship of those items to the depicted items will be apparent and is discussed below.

A. Lighting

As shown in FIG. 1, light sources 102 and 107 are panels supporting lighting elements shining down (panel 102) and up (panel 107). In the preferred embodiment, the lighting elements are LED light strips sufficient to light the length and width of sorting platform (111), a subsection thereof, or dishwashing tray 110. The lighting elements may also be comprised of any other light source including fluorescent lighting. As described below, the lighting elements illuminate sorting platform 111 (and anything thereon), a subsection thereof, or dishwashing tray 110 either from above (light source 102) or below (light source 107).

Although the preferred embodiment includes a plurality of light sources 102 and 107 with lighting elements, alternative embodiments include those with no lighting source, a single lighting source, or lighting panel(s) may be present but no lighting elements provided. In the case where at least one panel with lighting elements is present, that panel should provide sufficient lighting to enable the camera(s) 104 to capture images used to locate and recognize an item in dishwashing tray 110 and/or on sorting platform 111. In the case where no light sources are present, ambient lighting may be sufficient.

Although not depicted, an ultraviolet (UV) light source may optionally be included. UV light may be directed towards utensils at any stage of the sorting or separating method to provide a disinfecting/sterilizing feature.

B. Sorting Platform

In a preferred embodiment, sorting platform (111) is made of a material of sufficient thickness and properties to be translucent, such as high density polyethelene (HDPE). HDPE is commonly used in the food service industry for cutting boards and other items that contact food items and can be washed with commonly used cleansing products without degrading the material. With appropriate thickness and lighting, HDPE is translucent and can support the weight of a typical fully loaded dishwashing tray. In the preferred embodiment, the surface of the sorting platform has a matte finish which reduces glare from lighting which might affect the quality of images taken by camera(s) 104.

In a preferred embodiment, sorting platform (111) serves several purposes. First, sorting platform (111) provides a support surface for dishwashing tray (110). Second, when lit from below by light source (107), sorting platform (111) acts as a diffuser so that light is spread more evenly and glare/reflections from light source (107) are reduced. When viewed from above by camera(s) (104), this arrangement enhances the contrast of items placed on the surface of sorting platform (111). This may facilitate item recognition by software that processes images from camera(s) (104). Third, sorting platform (111) serves as a protective barrier that prevents and/or minimizes water and other debris from reaching areas of the machine below. For example, in the preferred embodiment, bin (113) collects roll ups deposited from wrapping area (112). Sorting platform (111) prevents and/or minimizes water or other debris from reaching bin (113) or other items below sorting platform (111). Fourth, sorting platform (111) also may serve as a surface on which to place or engrave optional fiducial markers. Finally, sorting platform (111) may serve as a sorting surface even when no dishwashing tray is utilized. In this mode of operation, items that are to be sorted are simply placed on sorting platform (111) for sorting.

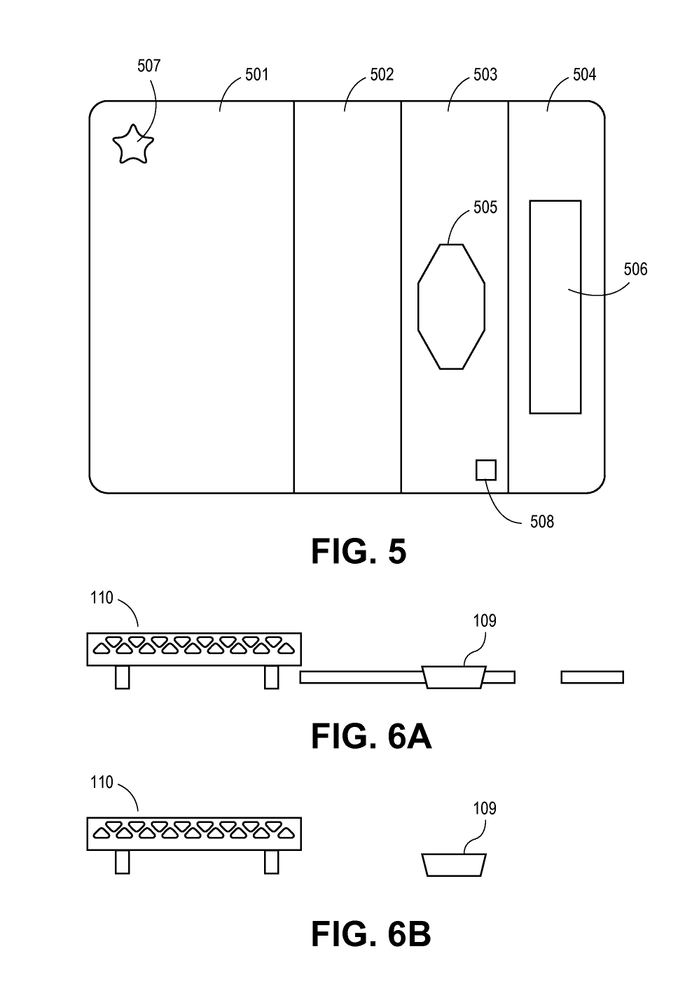

Fiducial markers are items placed in the field of view of a camera that are used as points of reference and/or for measuring and are described, e.g., in Bergamacso (2011) and Garrido-Jorado (2014). A fiducial marker is a marker of a known shape, size and/or location such that the marker serves as a reference point from which to determine the camera pose, and/or the relative position of the camera/marker to each other and/or to another item. For example, if a marker of known size and orientation is identified in an image, from that information the camera pose (i.e., the camera's relative position to the marker) can be determined. Further, the marker size can be used to determine the relative distance/characteristics of other items in the field of view. Thus, in a preferred embodiment, a fiducial marker(s) (507, 508) are embedded in the surface of sorting platform (111) such that they are within the field of view of camera(s) (104), as shown in FIG. 5. Identification of the marker(s) facilitates a determination of the camera(s) pose. Further, the marker(s) are placed at a known (or deduced) location(s) relative to the homing point of the CNC pick-up head (described below). With this information, the XY location of a utensil may be determined relative to the marker(s) and the pick-up head directed to that location to retrieve a utensil.

Finally, sorting platform (111) may serve as an additional surface on which to place/sort items after they have been removed from dishwashing tray (110). This functionality may facilitate sorting and selection strategies in some embodiments of the invention.

FIG. 5 is an exemplary sorting platform of the configuration shown in FIG. 2. In FIG. 5, area 501 is a dishwashing tray support area, area 502 is an additional sorting space area, area 503 includes a port (505) for a look up camera for item orientation, and area 504 includes the pass through aperture 108 where sorted, oriented items may be passed through for further processing. While at least area 501 is within the field of view of look down camera(s) 104 of FIG. 1, if one or more of areas 502-504 are also within the field of view of look down camera(s) 104 of FIG. 1, additional sorting and selection strategies may be enabled. Port 505 may comprise either a simple aperture through which a look up camera (e.g., camera 109) may look. Alternatively, port 505 may be covered by or be comprised of a transparent material (e.g., acrylic glass or Plexiglass) that serves as a protector for a look up camera mounted below.

During the process of assembling a utensil collection, there may be times when a required utensil is not recognized. For example, if a roll-up requires a knife, fork, and spoon, one or all of the items may not be recognized in the tray. This may occur because a desired item(s) is not in the tray or the item is in the tray but is not recognized. A desired item in the tray may not be recognized because the item is covered/occluded by other items. FIG. 2 shows several examples where one item obscures, an item below it. A strategy for addressing such a situation is to remove items from the tray (whether recognized or not) to locate a desired item. The removed items may be placed in area 502 and the process continued until either all the items have been removed from the tray, a desired item is revealed, and/or some other end condition. In addition to area 502, the areas of 503 and 504 that are not the viewing port 505 or pass through aperture 506 or any other area may also be used for this purpose. If a recognized (but initially unwanted item) is placed in these areas, when the item is desired it may be retrieved from these areas rather than the tray. These same areas may also be places where unrecognized items are placed to remove them from the tray, thereby uncovering items below them (in which case, areas 502-504 may not need to be within the field of view of look down camera(s) 104 of FIG. 1). These processes may be repeated until all the items have been removed from the tray, the desired item revealed, a desired number of roll ups is formed, or some other end condition.

FIGS. 6A and 6B illustrate alternative arrangements with a reduced sorting platform (FIG. 6A) or no sorting platform at all (FIG. 6B). In both figures, dishwashing tray 110 is supported by something other than the sorting platform but variants in which the dishwashing tray is supported by the sorting platform also may be used. Although FIG. 6A shows a reduced sorting platform that provides both some support for look up camera (109) and a sorting area, in FIG. 6B, the sorting platform is eliminated and look up camera 109 requires some other support. In the case of FIG. 6B where there is no sorting platform, fiducial makers may be placed on some other surface within the field of view of look down camera(s) 104 of FIG. 1 or eliminated entirely.

C. Cameras

1. Look Down Camera(s)

In FIG. 1, camera(s) 104 looks down on sorting platform 111 and anything thereon, including dishwashing tray 110. Thus, depending on the configuration, camera(s) 104 may see some or all of the view of FIG. 2.

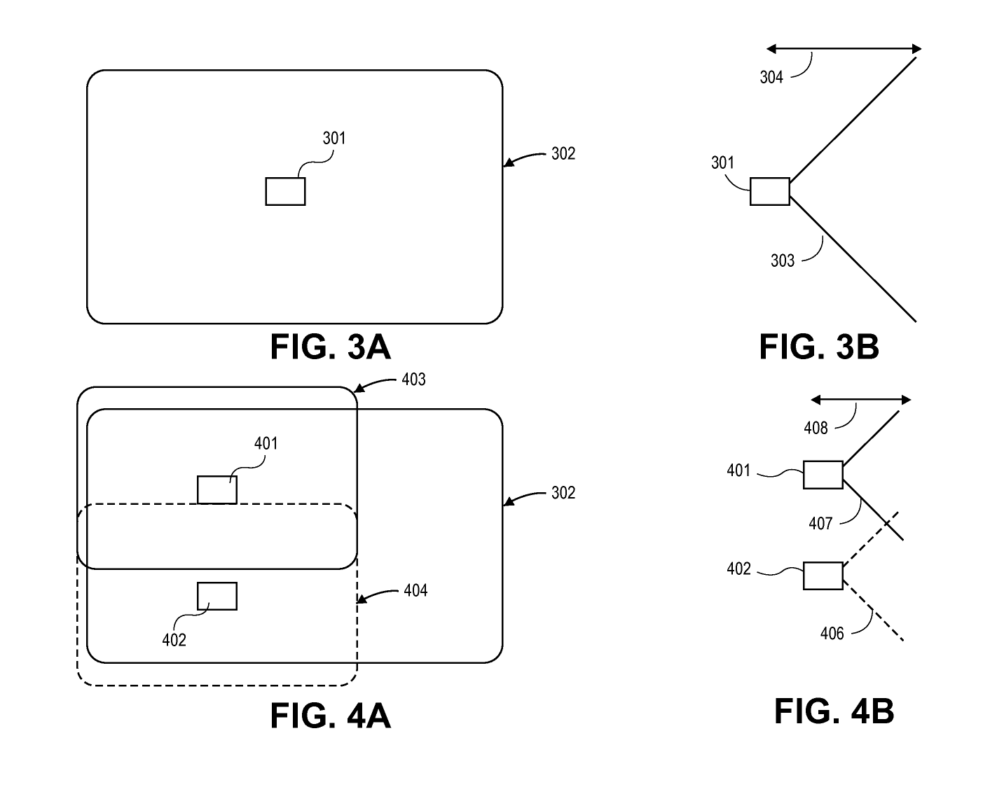

Camera(s) 104 may comprise one or more camera(s) with the number and arrangement thereof affecting both the field of view and the distance camera(s) 104 must be placed from platform 111 to achieve the desired coverage. FIGS. 3A-4B illustrate the trade-off. FIG. 3A shows an exemplary field of view (302) of a camera (301). As is common with modern cameras, the field of view may not have a square aspect ratio and the field of view depicted is a theater aspect ratio one (i.e., 16:9). Any aspect ratio sufficient to obtain a field of view of the desired area at the desired height may be used. As shown in FIG. 3B, camera 301 must be height 304 from the surface of platform 111 to achieve field of view 303.

FIG. 4A shows a two camera configuration with cameras 401 and 402 having field of views 403 and 404 respectively. As shown, the two cameras have a somewhat smaller total field of view, than camera 301. However, as shown in FIG. 4B, height 408 that achieves fields of view 407 and 406 is lower than height 304. As a result the total height of the machine may be reduced. Although a “stacked” arrangement of the cameras is shown in FIG. 4A, alternative camera configurations may be used including side-by-side arrangements.

In the preferred embodiment, camera(s) 104 of FIG. 1 are two commercially available, high definition, web cameras in the arrangement shown in FIG. 4A. Additionally or alternatively, a depth sensor (such as the Microsoft Kinect) may be used to gather image/depth data of items on the sorting platform.

2. Look Up Camera

In addition to the look down camera(s) 104 of FIG. 1, the preferred embodiment includes look up camera 109. As shown in FIGS. 1 and 2, look up camera 109 “looks up” through sorting platform 111 through aperture 207. In the preferred embodiment, items held by the pick-up head 106 are moved to be above camera 108 which looks up to view the items or portions thereof.

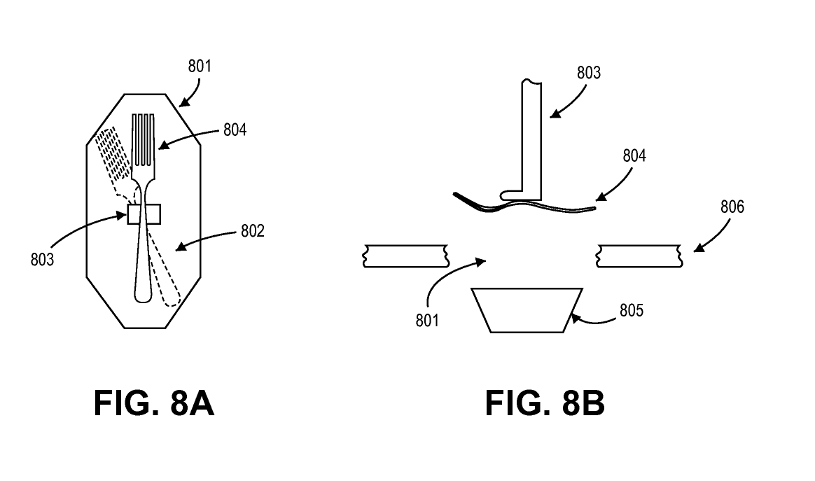

FIGS. 8A and 8B illustrate item orientation. There, pick-up head 106 of FIG. 1 is shown, in illustrative/simplified form, as item 803 while aperture 207 is shown as 801. When an item is held by pick-up head 803, the item may or may not be in the desired alignment, particularly with respect to pass through aperture 208 of FIG. 2. To check the orientation of an item held by pick-up head 803, the item is moved over aperture 801 as shown in FIG. 8A. There, look up camera 805 looks up at the item and views the orientation of the item. If the item is not in the desired orientation, pick-up head 803 (or a portion thereof) rotates until the item is in the desired orientation. Thereafter, pick-up head 803 may move the item over and through pass through aperture 208 of FIG. 1 for further processing.

In addition to orientation, look up camera 109 may also serve as a means to obtain additional images of the item actually picked up for further object recognition. These images may serve as a way to verify that the item picked up was the desired item, and only the desired item. For example, although a spoon may be desired and was selected, the spoon may have become entangled with a fork such that both items were picked up. Camera 109 is a source of images of the item(s) actually picked up for item verification before further processing.

By looking up at the item (rather than from above), the view of the item is not obscured by the XYZ stage 105 or pick-up head 106. In alternative embodiments, either in place of or in addition to camera 109, a camera or cameras may be mounted in other locations (for example, on pick-up head 106 or XYZ stage 105 themselves) to obtain item imagery. Yet another alternative is to use the camera(s) 104 for such a task. Yet another alternative is to not attempt to correct item orientation or to verify the item and eliminate this function and camera 109.

Although all the cameras are depicted as direct view cameras, mirrors may also be used to mount the cameras at different locations while still viewing the desired region. Thus, for example, camera(s) 104 may be mounted at a location other than directly above and looking down at platform 111. Instead, camera(s) 104 may look at mirrors which redirect the view to observe platform 111.

In addition, rather than looking up or down at the item, camera 109 may be mounted (either on XYZ stage 105 or pick-up head 106 or on the structure of the apparatus itself) to view the item retrieved from the side. Likewise, camera(s) 104 may be mounted so as to not be perpendicular to platform 111, but mounted at an angle. Mounting in this fashion may facilitate imaging the item held by pick-up head 106 while at the same time viewing platform 111.

Permutations and combinations of all of these camera locations may be employed. Additionally or alternatively, a depth sensor (such as the Microsoft Kinect) may be used to gather image/depth data of item held by the pick-up head.

D. XYZ Stage

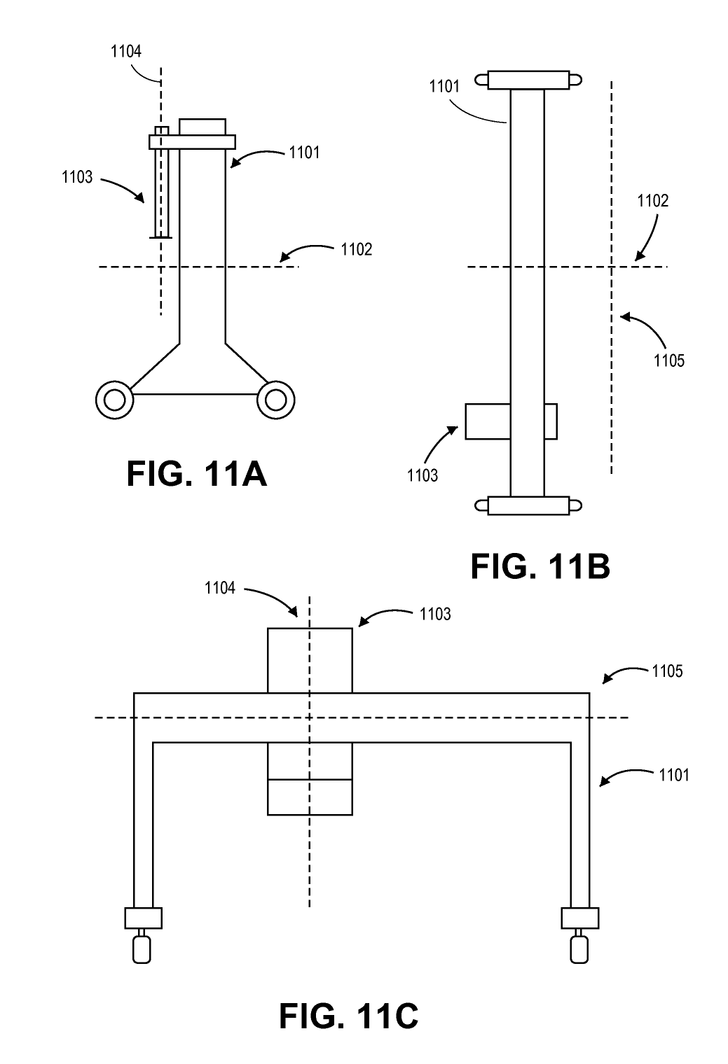

FIG. 1, XYZ stage 105 including pick up head 106 is described in greater detail. FIGS. 11A, 11B, and 11C are three views of the XYZ stage from different vantage points. As shown in FIG. 11A, the XYZ stage includes a gantry 1101 supporting a pick-up head 106. The gantry itself comprises three components: an X axis (generally 1101), a Y axis, and a Z axis (1103). The X axis moves along the path of axis 1102 while the Z axis moves along the path of axis 1104. Movement along the axis is provided by motors or other motive sources that drive the relevant components along each axis. Wheels are shown for illustration purposes only and the actual motion may be provided by wheels, lead screws, linear motors, rack and pinion, pneumatics, linear rail or belt drives.

FIG. 11B is an overhead view showing the XY axes of movement (1105 and 1102 respectively).

FIG. 11C is a view showing the YZ axes of movement (1105 and 1104 respectively).

While the figures depict the X axis as the major axis, the major axis may be any axis.

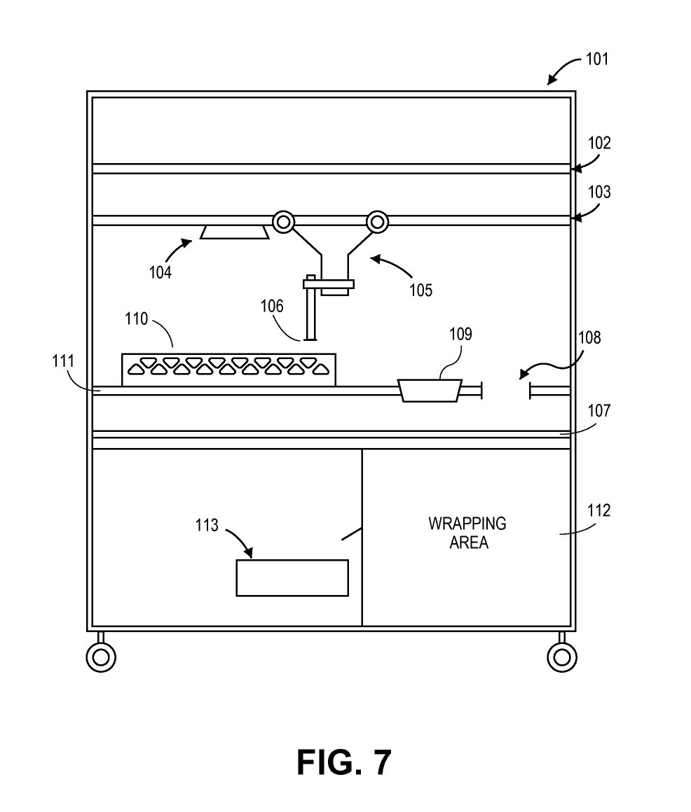

FIG. 7 depicts an alternate arrangement where XYZ stage 105 hangs from panel 103. This arrangement eliminates mechanical interference between XYZ stage 105 and elements below the surface of sorting platform 107. For example, wrapping area 112 may include structure that rises above or meets the surface of sorting platform 107. That structure may interfere with the movement of XYZ stage 105 if it rides on or is supported by panel 107. Thus, the alternative arrangement eliminates this potential interference. Another advantage of having XYZ stage 105 hang from above is that the mechanical components of XYZ stage 105 are placed in a location where they are less likely to be damaged by having items fall onto them. In this arrangement, dishwashing trays are not loaded over an operating axis and its mechanical components. That is, the dishwashing trays will not need to pass over a rolling surface for the axis. This arrangement eliminates one avenue for potential malfunction from items interfering with the operation of the XYZ stage.

E. Pick-Up Head

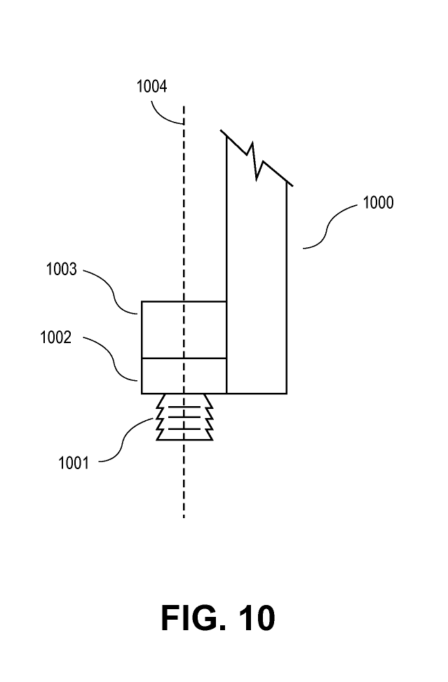

FIG. 10 shows a more detailed view of pick-up head (106) as attached to XYZ stage (105) of FIG. 1. More specifically, the pick-up head may include a suction cup (1001) through which a vacuum is applied to pick up an item. As shown in FIG. 10, the suction cup is a round, bellows type suction cup but other types of suction cups (e.g., oval, non-bellows) may be used.

A bellows type cup reduces the accuracy needed in Z axis placement to retrieve an item. When retrieving an item, the precise Z height at which the item is located may not be clear, may be unknown, or may change. For example, in one mode of operation, the X and Y axes locations of the item to be retrieved are determined, while the Z axis remains unknown or known only in a general sense (e.g., between the bottom and top of a tray). The pick-up head may be moved to the correct X and Y locations. From some starting height, the pick-up head may be progressively lowered on the Z axis with the vacuum on while monitoring the vacuum pressure. When the vacuum pressure changes to indicate that an item has been retrieved, the downward Z axis movement is stopped. In such an operation, the bellows type cup provides a margin of variability that can assist in dealing with the height differences encountered. In addition, when contact is made, the item to be retrieved may move (e.g., be pushed down into the tray) and a bellows type cup facilitates addressing height changes. Finally, the item to be retrieved may itself have height variances (e.g., the cup end of a spoon or the tine end of a fork) and a bellows type cup facilitates handling this variability. Where even greater Z axis variability is desired, a level compensator (e.g., the Piab LC10-F0510) (not shown) as part of the Z axis structure may also be provided.

Although a single suction cup may be used, alternative arrangements using multiple suction cups may also be employed. Multiple suction cups may facilitate item pick up because all of the vacuum force need not be applied at a single point. Two or more suction cups spread the item weight among the cups, reducing the force each cup needs to apply to retain an item.

In a preferred embodiment, the capability of weighing the retrieved item is also provided. An exemplary weighing component is shown as item 1002. Such weighing may be either individual (i.e., weighing only the retrieved item) or indirect (i.e., weighing the retrieved item as attached to something else). The weighing capability may be provided through the use of strain gauges, load cells, or force sensitive resisters, e.g. Alternatively, the weight may be deduced by closely monitoring the vacuum pressure needed to lift and/or retain the retrieved item.

In addition, to accommodate item orientation correction, in a preferred embodiment, the capability of rotating the retrieved item held by suction cup 1001 is also provided. An exemplary motor to provide rotation is shown as item 1003. In operation, motor 1003 rotates at least suction cup 1001 (to which a retrieved item is attached by suction) about the axis 1004 to rotate the retrieved item.

Not shown in FIG. 10 is an optional background plate/mask. The view from a lookup camera (such as camera 109 of FIG. 1) will include the item(s) retrieved but will also include views of portions of the pick-up head as well as possibly the XYZ stage and other portions of the structure. Thus, a background plate/mask may be mounted to the XYZ stage (preferably just above the suction cup 1001) to obscure the view of the gantry itself and/or portions of the structure that are within the field of view of look up camera 109. Including a background plate/mask may provide a clearer image of the retrieved item that minimizes images of items not of interest. In the preferred embodiment the background plate/mask is circular in shape and made of HDPE, though other shapes and materials may also be used to accomplish the same purpose.

F. Pneumatic Air Supply/Pump

Not shown in the figures is a pneumatic air supply and pump that generates the vacuum used by the pick-up head to retrieve an item. In the preferred embodiment, a pneumatic pump operates to store compressed air in a tank. That compressed air is fed to a venturi vacuum pump generator (e.g., a Piab piCompact pump). The vacuum generated is then fed by a line to suction cup 1001. In the preferred embodiment, the tank storing compressed air is optionally equipped with a pressure sensor that is connected to or communicates with the control computer (or other controller). This allows the control computer to monitor the pressure in the tank to determine if it is at the desired level to generate the vacuum.

Alternatively, compressed air may be provided by any air source such as “shop air”, where available. Alternatively, a vacuum pump not reliant on compressed air may be provided.

The vacuum pump is also connected to or communicates with the control computer (or other controller) which controls when the vacuum turns on and off and may have additional sensors and features. For example, the Piab product includes a vacuum sensor to measure the vacuum pressure generated and also includes a blow-off feature to blow off any attached item when the vacuum is turned off. In addition, the Plab product includes a vacuum “hold” feature where a valve is activated once a vacuum is applied to hold the vacuum while turning off the air supply. This minimizes the amount of air required to maintain a vacuum and the strain put on the air pump. In operation, the control computer (or other controller) monitors the vacuum pressure for changes. A substantial increase in vacuum pressure indicates that something is attached to the pick-up head.

G. Wrapper

Shown as item 112 of FIG. 1 is the area where wrapping of utensil assemblies in napkins occurs. Assemblies of utensils are presented and wrapped in a napkin to form a roll-up. The roll-up may be further secured through a band (with or without adhesive) to prevent the roll-up from coming apart. Mechanisms that will roll utensil assemblies in napkins are well known in the art and are described, e.g., in U.S. Pat. No. 6,615,566 (Heisey); U.S. Pat. No. 6,837,028 (Miano); U.S. Pat. No. 6,918,226 (Hellman); U.S. Pat. No. 7,076,932 (Rubin); and U.S. Pat. No. 7,322,172 (Hoffman).

Once rolled, the roll-up is deposited in a bin (113) or other container for later retrieval. FIG. 1 shows collection bin 113 within apparatus 101. Alternatively, bin 113 may be located outside the envelope of apparatus 101 with a chute or other mechanism directing the roll-up into the bin. Alternatively, bin 113 may be located within the envelope of apparatus 101 but not behind a door (described below) to allow roll-up retrieval without suspending or stopping the roll up process.

In an alternative embodiment, the wrapping function does not exist such that only the sorting and orienting or sorting capabilities are utilized.

H. Control Components

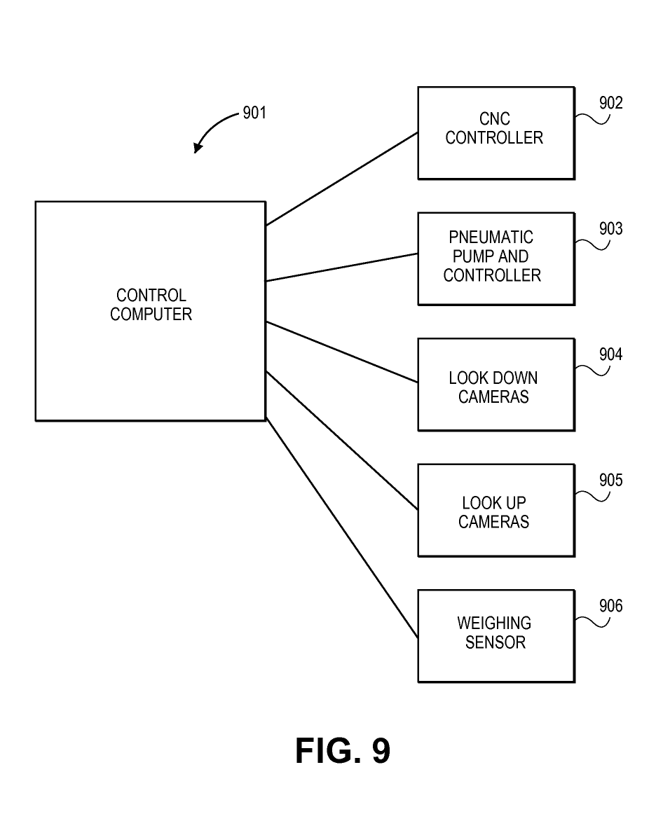

FIG. 9 shows the general relationship of the control components not shown in the other figures. As shown there, a control computer 901 communicates with and controls the various features of the apparatus. The control computer executes software that performs the various tasks as described above and below. The control computer 901 may be a separate device (for example, an Intel i7 processor running the Windows operating system and the control application) or it may be included as part of another controller (e.g., CNC controller 902). Likewise, other controllers (e.g., the CNC controller) may be incorporated in the control computer.

In addition, control computer 901 may include or be connected to a graphics processing unit (GPU) such as those marketed by NVidia, Inc. A GPU speeds graphics operations and can also be used for more general purpose computing tasks, particularly those susceptible to massively parallel operations. When programmed to perform general purpose computing tasks, non-graphics operations such as image processing may be sped up. General purpose programming frameworks for GPUs include OpenGL and CUDA.

As shown, the control computer 901 is connected to the look down camera(s) 904, look up camera(s) 905, CNC controller 902, pneumatic pump and controller 903 and optional weight sensor 906. Images from the look down camera(s) are fed to the control computer which processes the images and performs object recognition. When an item is recognized (or some other action is determined), the control computer directs the CNC controller to move the XYZ stage (with pick-up head) to the appropriate location.

In one embodiment, the CNC controller is the TinyG open source CNC controller manufactured by Synthetos. That device contains motor drivers and interfaces and its own processor and can accept Gcode commands and direct the attached motors to move the XYZ stage to the indicated location. In this embodiment, the control computer issues Gcode commands to the TInyG, which then operates the motors to move the XYZ stage to the desired location. When the XYZ stage is at the specified X and Y axis locations (either as part of coordinated multi-axis move or as a separate step), the pick-up head is moved downward on the Z axis. The control computer directs the pneumatic pump and controller to turn the vacuum on, and with the pick-up head moving down on the Z axis, the control computer monitors the sensed vacuum pressure for a change indicating that something has become attached to the pick-up head. Alternatively, the pick-up head may reach the maximum allowed Z axis travel.

When the control computer determines that something is attached or the maximum Z axis travel is reached, the control computer directs the CNC controller to begin upward movement of the pick-up head along the Z axis. If an acceptable vacuum has been achieved and a vacuum maintaining switch is available, the control computer directs the pneumatic pump and controller to activate the switch to maintain the vacuum and the vacuum pump/air flow is turned off. In addition, a “blow off” capability may be provided. When an item is attached to the pick-up head and it is determined to release the item, in addition to simply releasing the vacuum switch (and thereby releasing the vacuum), the item may be blown off by providing positive air pressure to blow the item off the pick-up head.

When the optional weight sensor is included, the control computer determines the weight to compare the weight of the retrieved item to the item/image library.

Thereafter, the control computer directs XYZ stage to move to an area above the look up camera 109. While above the look up camera 109, the control computer retrieves images from the look up camera and determines the item orientation (and also optionally performs additional object recognition). Thereafter, the control computer directs the CNC controller to rotate the pick-up head to align the retrieved item in the desired orientation. Alternatively, if the retrieved item is not recognized, then the retrieved item may be deposited either back in the dishwashing tray or some other location.

Once aligned, the control computer may direct the CNC controller to move the pick-up head to the area above the pass through aperture and then turn off the vacuum/release the vacuum switch to release the item or both lower the pick-up head to some Z axis location and release the item.

X, Y and/or Z axis limit switches may also be included. These switches indicate that the XYZ stage has reached a limit of travel on an axis and the CNC controller/control computer stops motor movement along the axis tripping the switch.

In addition, control computer 901 may also be provided with a connection (either wired or wireless) to the Internet or another network or computer. This connection may be used to remotely monitor the various parameters of the apparatus. Such parameters may include the number of roll-ups performed, number of sorting operations, consumables status (e.g., empty, full, or state), general status (e.g., ready, in operation, error state), elapsed time of operation, motor and controller status and other parameters. This information may be used to remotely diagnose the apparatus for maintenance. In addition, this information may also be used to facilitate per roll-up charging for use of the machine. With remote monitoring, an operator can charge for each use of the machine without needing to physically visit each device to gather information on uses.

In addition, a wired or wireless connection may be used to provide an update capability to update the control application with bug fixes or new or different features. In addition, the data files associated with the application may also be updated. For example, new data files associated with the item/image library may be provided to allow recognition of different items without requiring the operator to create those images.

I. Exterior/External View

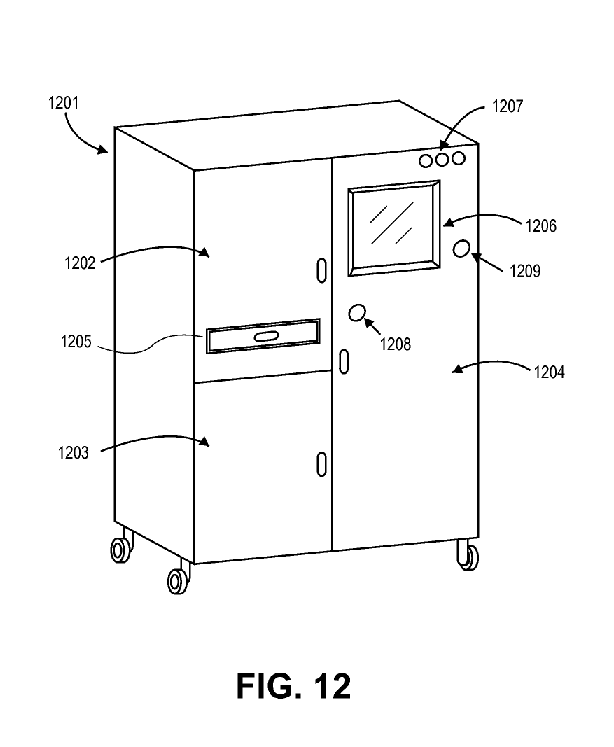

FIG. 12 shows an external view of the apparatus. As shown, the apparatus 1201 includes three doors or panels (1202, 1203, and 1204) that open to provide access to portions of the internal workings. Door 1203 corresponds to the area where completed roll-ups may be stored in a bin and/or where consumables (napkins and/or adhesive tabs/tape/strips) may be stored or loaded. Door 1202 corresponds to the portion of the sorting platform where the dishwashing tray may be present and may also include a smaller door/slot 1205 through which dishwashing trays may be loaded or unloaded. Thus, in typical operation, a user would need to only access door/slot 1205 and would not need to open the larger door 1202. Door 1204 corresponds to the portions of the apparatus containing the wrapping area and portions of the sorting platform. Thus, in operation, the user would typically not need to open door 1204. As a safety feature, some or all of the doors or slots may be provided with switches/interlocks indicating whether the door/slot is opened or closed. The control computer may monitor these switches to prevent machine operations when a door or slot is open. In addition, all or portions of each of the doors may be transparent to allow a user to view inside the apparatus to review the number of roll-ups in the bin or utensils remaining to be sorted. Transparent doors of this type may be made from acrylic or Plexiglass, e.g., and allow the user to determine the status without opening a door and interrupting machine operation.

As shown, the apparatus optionally includes other features, including a display (1206), status light(s) (1207), start button (1208) and emergency stop (1209). Display 1206 may be a touchscreen and be used to display information to the user and accept user input. For example, display 1206 may show the number of roll-ups in the bin, any status information and may be interactive. When used interactively, display 1206 may allow the user to select different roll-up configurations (e.g., fork/knife/spoon or fork/knife, etc.) or to configure the apparatus initially by inputting reference images and weights in response to application prompts. When a touchscreen is not used, a keyboard connection (either wired or wireless) may be provided.

Status light(s) 1207 are optionally included to allow an indication of the apparatus state from longer distances. The status light(s) may use colors to indicate condition. For example, red may indicate that attention is needed (e.g., no utensils, not the desired combination of utensils, bin full), yellow that supplies are needed (e.g., napkins, adhesive strips, or utensils running low), while green may indicate that the apparatus is ready or running as expected. In addition to or in the alternative to color, flashing light(s) may be used to convey information. Status light(s) 1207 enable a user to quickly determine the apparatus condition from across a room, e.g., without having to come closer and examine information displayed on display 1206.

Optional start button 1208 provides a quick way of starting the apparatus without interacting with display 1206. Thus, a user could load a dishwashing tray through slot 1205 and then simply press start button 1208 to start processing.

Emergency stop (also known as an “E-stop”) 1209 provides a large button that can be pressed in an emergency situation to stop all machine movement.

In a preferred embodiment, the structure of apparatus 1201 is constructed of stainless steel or aluminum. In addition, in a preferred embodiment, the interior of the structure is provided with a matte finish in order to minimize glare/reflections caused by the light panels.

J. Software Aspects and Process Description

The control computer executes instructions comprising a control application which processes received data and controls the various aspects of the apparatus. In the preferred embodiment, the video related operations (described above and below) are implemented using the OpenCV open source computer vision library of routines. OpenCV is well known to those of skill in the art and is one of the most widely used computer vision libraries. While the preferred embodiment utilizes OpenCV routines, any algorithms offering substantially the same overall functionality as the mentioned routines may be employed.

1. System Calibration

Several aspects of the apparatus benefit from calibration to function optimally.

a) Cameras

Due to imperfections in the lenses and the “fish-eye effect” resulting from the use of lenses, the image seen by cameras is distorted. Calibration of cameras (or more specifically the images from the cameras) minimizes or eliminates the distortions caused by these defects. Calibration is accomplished by imaging a target with known features, identifying distortions in the image (by comparing the known features to what is actually imaged), and generating a map/matrix/function that reflects the transformation to be applied either to each pixel imaged or the image more generally to transform the perceived image into an image in which the distortions are minimized or corrected. This transformation map/matrix/function may thereafter be applied to each scene imaged by the camera to minimize or correct the distortions. Because the distortions may be unique to each camera (i.e., each camera may have different defects in the lenses, etc.), calibration may be performed on each camera independently.

In the preferred embodiment, only the look down camera(s) are calibrated. While the look up camera also suffers from distortions, because only the general orientation of the item is needed, an uncalibrated image is sufficient for that purpose. Alternatively, the look up camera may also be calibrated and that may be desirable if the look up camera is used for a purpose other than/in addition to utensil orientation. For example, if the look up camera is used for object recognition purposes to identify the picked up item, then an undistorted image may be preferable.

In addition to calibration, color balancing may also be performed to result in a color corrected image. Color balancing may aid in object recognition by enhancing edge or keypoint detection or when color is an object descriminator.

b) CNC Platform/Fiducial Markers

The CNC platform itself needs to be calibrated in two ways. First, the “home” (i.e., the XYZ zero location) must be determined. This may be performed by using limit switches which activate when one or more stages move into contact with them, which position is designated the minimum position. Once at the minimum position, that position is designated the “zero” location from which future movements may be measured relative to. While typically, assigned a value of zero, any arbitrary value may be assigned or recorded as the zero location. Alternatively, one or more limit switches may be eliminated and any arbitrary position designated the zero position or “home” of the machine.

The actual pick-up head may be offset (in either the X or Y axes or both axes) from the home position of the machine and the offset amount may be measured or determined and this value stored. Thereafter, the offset amount may be combined with the machine home position to allow the control computer to move the pick-up head to any designated location.

Where fiducial markers are used, the position of the markers relative to the home position should also be determined. This can be accomplished by simply measuring the position in an initial machine setup operation that is not repeated each time the machine is used. For example, by first moving the machine to the home location and then moving the pick-up head In such a situation, the relative position is stored for use when the machine is next turned on. Alternatively, the fiducial position may be designated arbitrarily by the user. In addition, the fiducial marker position in the retrieved images from each camera should also be determined. With these data points (machine home (including pick-up head offset), fiducial marker position relative to home, fiducial position in image, the absolute location of a recognized item may be determined by knowing its location relative to the fiducial position in the image. This information may be used to determine which XYZ location to move the pick-up head to for an operation.

c) Pneumatic/Vacuum Pump

While not technically part of a calibration process, as part of the machine startup process, the pneumatic pump may be activated to fill a tank to a preset pressure. When the tank is at the desired pressure, the apparatus is ready to generate a vacuum using the vacuum pump at the direction of the control computer.

2. Image Processing and Item Retrieval
a) Image Pipeline

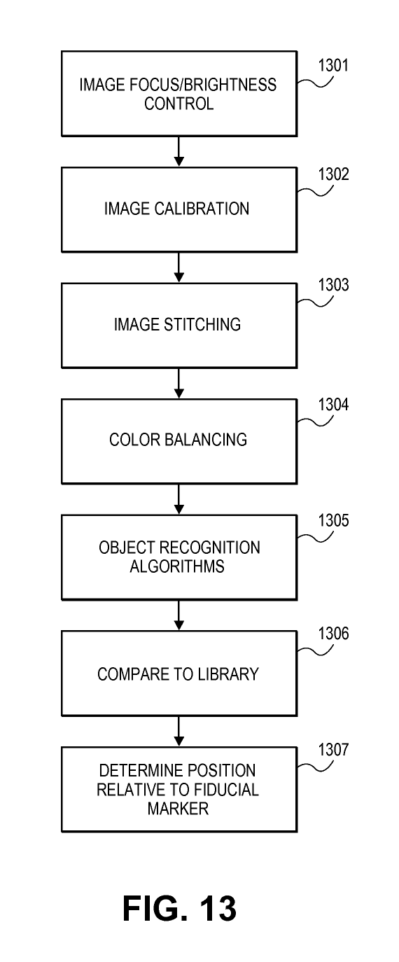

Images retrieved from the cameras are processed in a pipeline (shown in FIG. 13) that provides prepared images on which object recognition is performed. While the processing of images from a single camera is next described, the same process may be applied to images retrieved from multiple cameras. While the steps in the pipeline are described herein in an order, other orderings of the image pipeline steps may be used and/or steps eliminated or added depending on the desired application.

Typically, focus and brightness control are performed by the camera itself such that the provided image is already focused and brightness controlled. However, if these operations have not already been performed, and are available, then focus a brightness control filter are applied.

The calibration transformation matrix/map/function is applied to minimize or correct the distortions. Either before or after, the image may also be color balanced to even out the color differences in the image.

In the preferred embodiment, if there is more than one camera 104, the images provided by each camera are processed independent of the processing of another camera 104. Thus, each camera 104 sees a somewhat different image and object recognition is performed on each image independent of the image retrieved by another camera. This approach minimizes the processing required to evaluate an image which may result in faster image processing, i.e., more frames per second. One disadvantage of this approach is that the overall control program must be more complex because it must evaluate two images independently and then choose which image on which to take appropriate action.

In an alternative embodiment, images from multiple cameras 104 are stitched together to form a single image on which object recognition is performed. This approach has the advantage that the overall control program may be simplified because there is only one resulting image on which to take appropriate action. Disadvantages of this approach include increased processing required to stitch the images together and distortions and incongruities resulting from the image stitching itself.

b) Image/Item Library

The process of object recognition compares characteristics of an input image to characteristics that describe or relate to the item to be recognized. In the present invention, this is accomplished through the use of a reference image/item library that contains images of the items to be recognized and/or the characteristics of the items to be recognized. For example, if a fork is to be recognized, an image of a fork is stored in the library and/or characteristics of the fork are stored. Such characteristics may include keypoints, contours, perimeter, area, moment of area or any other basis on which discrimination is to be accomplished. The same characteristics are then computed for the input images and compared to the values stored in the image/item library to determine if there is a match and the item is recognized. Thus, data corresponding to a fork, knife and spoon, e.g., may be stored in the image/item library and then compared to images retrieved from the camera(s) 104 or 109 to determine if there is a match. In some instances, a margin of error may be applied so that only approximate matching is required to determine if a match exists.

In addition, more than one image of each item desired to be recognized may be stored. For example, multiple images of forks may be stored showing the fork in either the same or different orientations (e.g., tines up, tines down, tines on top, tines on bottom, on its side to the right, on its side to the left, etc.). The differing images allow for multiple modes of gathering characteristics which may improve object recognition. Even where the item is in the same orientation, multiple images may have value because lighting and sensor variations mean that an image taken from the same location of an item in the same pose may have differences that result in characteristic differences.

When processing, images from the camera(s) 104 and/or 109 may be compared to all of the images/items in the library or merely a subset. For example, if a fork is desired, the images from the camera(s) may be compared to only the images/items in the library that correspond to a fork. Reviewing only a subset may speed processing and therefore result in faster system operation.

Where the optional weighing is employed, the image/item library also contains one or more weights corresponding to the item stored in the library. These weights may be either be entered directly through an input screen/keyboard or sample weights obtained through the pick-up head may be taken. When processing, after an item is retrieved, the weight of the item is compared to weights stored in the image/item library to determine if there is a match and/or to confirm that the expected item was in fact retrieved. Again, a margin of error may be applied to the weights to allow for variations between individual items and allow approximate matching.

c) Image Processing Algorithms and Object Recognition

In the preferred embodiment, many of the image processing functions are implemented using routines available in OpenCV. Utilized functions include: findChessboardCorners (for camera calibration), Canny (edge detection); findContours (locate contours in image); and remap (to correct image with calibration values). In addition, object recognition may be performed using various keypoint detectors and feature extractors (e.g., SIFT, SURF, FAST, BRIEF, ORB) to detect keypoints in images and extract the features thereof for use in matching to similar features calculated for reference images stored in the item/image library. In addition, shape matching and other approaches to object recognition may be used.

In operation, items may be retrieved in any specified order and/or combination and/or no order by repeating the above described recognition and placement processes. Thus, for example, if a fork, knife, spoon combination in that order is specified, then, first a fork is sought by comparing the processed image from the camera(s)/weight to the fork characteristics stored in the library. Once a fork is recognized, retrieved and oriented and deposited in the wrapping area, then a spoon, and then a knife are processed in the same fashion. In addition, any combination of desired items may be specified (e.g., fork/knife, fork/knife/spoon/soup spoon, salad fork/fork/knife, etc.).

K. Pick Up Strategies

Once an item is selected to be picked up, the place on the item from which to retrieve it may be selected according to different strategies. In one strategy, once an item is recognized, the contours of the item are identified and the portion with the largest area (i.e., the moment of area) is selected as the location on which to place the suction cup. Alternatively, the center of gravity may be estimated or determined and that point selected as the location on which to place the suction cup. Yet a third strategy may be to simply select half way along the length of the item as the pick up point. In addition, the strategies may be combined, alternated, or used in a cascade fashion.

L. Sorting Strategies

When processing items, different sorting strategies may be employed. In creating a collection of utensils, a particular order of utensils may be utilized (e.g., first a knife, then a fork, then a spoon). Alternatively, one or more items may have already been retrieved and a particular utensil or utensils are needed to complete a set. In either case, the selection of a particular item may be desired but the item may not be recognized. In that case, a sorting strategy may be employed.

One strategy is to select a recognized (but not desired item) in the dishwashing tray, retrieve the item, and then move the retrieved item to an open area on the sorting platform. This process may be repeated until either no more items (whether desired or not) are recognized within the dishwashing tray or until a desired item is retrieved. In an alternate strategy, the retrieved item may be placed in an open area of the dishwashing tray itself. Yet another aspect of a sorting strategy may be to segregate retrieved but undesired items by type in different storage areas. For example, forks may be stored in one area, knives, in another, etc.

If sorting areas are utilized and items stored therein, when an item is needed, it may be retrieved from the storage area rather than the dishwashing tray. The availability of identified items in a storage area may speed making assemblies because the items in the storage area have already been recognized and are known to not be entangled with another item. Thus, selection and retrieval of an item from the storage area may be faster than an item from the dishwashing tray. In one embodiment, the control application records where each item is placed for later retrieval. In another embodiment, the item is recognized for retrieval simply because it is within the field of view of the look down camera(s).

One aspect of these strategies may be to utilize the look up camera and the orientation capability to maximize the space that may be used to store undesired items. For example, by orienting an the long axis of a utensil or item at forty-five degrees, more items may be stored in an area without overlapping than might be stored otherwise.

In addition, if a retrieved item is not recognized (e.g., the weight does not correspond to a programmed weight), then the unrecognized item may be stored either in a designated area of the sorting platform or a designated area of the dishwashing tray or some other location.

As discussed, it is possible that AN item may become entangled with another item such that picking one of them up also picks up the other item. Where weighing or item verification capabilities are provided, this condition may be detected (and/or simple detection of an unrecognized item) and an appropriate response made. One response is to segregate the item in area of the dishwashing tray, sorting platform or other location designated for this purpose. Items placed in this area may be separated or addressed by personnel servicing the equipment. By removing the item from the area of active sorting, the item will not occlude items below. Alternatively, another response is to release the item and let it fall form some height. The resulting impact of the item may act to separate any entangled items so that processing of those items may continue.

M. Determining the End Condition

The apparatus will have a means of knowing when it has completed its task. When a task is completed, the apparatus may optionally signal the user to replace the dishwashing tray or for other service or attention by lighting the status lights 1207. The end condition may be determined to have occurred when, 1) no more items are recognized to be sorted (either in the dishwashing tray 110 or otherwise on the sorting platform); 2) no more desired items are recognized and no further sorting of undesired items can be accomplished or is desired; 3) no more consumables (e.g., napkins and/or adhesive bands); 4) the roll up bin is full; or 5) some error condition.

Although various aspects and embodiment have been disclosed herein, other aspects and embodiments will be apparent to those skilled in the art. It is particularly emphasized that while the above description is primarily in the context of utensil sorting and wrapping, the concepts disclosed herein are suitable for and applicable to any operation where item sorting is desired, including those where item orientation and/or wrapping is not desired). Thus, for example, the disclosure herein would be applicable to any singulate, sort, pick and place operation. The various aspects and embodiments disclosed herein are for purposes of illustration and are not intended to be limiting, with the true scope and spirit being indicated by the following claims.

What is claimed is:

1. A system for sorting comprising:
An x-y-z stage including a suction cup attached thereto;
A camera;
A computer connected to said x-y-z stage and said camera; and
A translucent platform for sorting, said platform mounted below said camera and said x-y-z stage.

2. The system of claim 1 wherein said camera comprises two or more cameras above said platform.

3. The system of claim 1 further comprising a camera mounted below said platform.

4. The system of claim 1 further comprising a light source mounted below said platform.

5. The system of claim 1 further comprising light sources mounted above and below said platform.

6. The system of claim 1 wherein said platform comprises HDPE.

7. The system of claim 1 wherein said platform includes a fiducial marker that is visible to said camera.

8. The system of claim 1 wherein said suction cup is a bellows type suction cup.

9. The system of claim 1 further comprising a utensil wrapper.

10. The system of claim 1 wherein said suction cup is connected to a rotation motor.

11. A system for sorting comprising:
A computer connected to an x-y-z stage, said x-y-z stage including a vacuum gripper;
A camera connected to said computer; and
A surface including a fiducial marker within the field of view of said camera.

12. The system of claim 11 wherein said camera comprises two or more cameras above said surface.

13. The system of claim 11 further comprising a camera mounted below said surface.

14. The system of claim 11 further comprising a light source mounted below said surface and wherein said surface is translucent.

15. The system of claim 11 further comprising light sources mounted above and below said surface wherein said surface is translucent.

16. The system of claim 11 wherein said surface comprises HDPE.

17. The system of claim 11 wherein said vacuum gripper is a bellows type suction cup.

18. The system of claim 11 further comprising a utensil wrapper.

19. The system of claim 11 wherein said vacuum gripper is connected to a rotation motor.

20. A method for sorting comprising the steps of:
Taking an image of one or more items on a sorting platform;
Identifying an item in the image;
Determining the location of the item in the image relative to a pick-up head;
Moving said pick-up head to the location of the item;
Picking up the item using a suction cup; and
Moving said pick-up head and item to a different location.
